(19) United States
(12) Patent Application Publication
(10) Pub. No.: US 2024/0220401 A1
(43) Pub. Date: Jul. 4, 2024

(54) CONTINUOUS INTEGRATION AUTOMATED TEST SYSTEMS AND METHODS, ELECTRONIC DEVICES, AND STORAGE MEDIA

(71) Applicants: Beijing Zhongxiangying Technology Co., Ltd., Beijing (CN); BOE Technology Group Co., Ltd., Beijing (CN)

(72) Inventors: Mutu JIRI, Beijing (CN); Yun ZHANG, Beijing (CN)

(21) Appl. No.: 17/914,211

(22) PCT Filed: Oct. 27, 2021
(86) PCT No.: PCT/CN2021/126766

§ 371 Date: Sep. 23, 2022

(30) Foreign Application Priority Data
Apr. 28, 2021 (CN) 202110469930.1

(51) Int. Cl. G06F 11/36

(52) U.S. Cl. CPC G06F 11/3688; G06F 11/3604; G06F 11/3692

(57) ABSTRACT

The present disclosure relates to a continuous integration automated test system and method, an electronic device, and a storage medium. The system includes: a deploying server, configured to, in response to detecting one or more events each indicating deploying project codes to a tested server, for each of the one or more events, acquire a test script of a project to which the project codes belong, and send the test script to a testing server, then send a control instruction for executing the test script to the testing server; the testing server, configured to receive the test script through a designated port and store the test script in a corresponding project folder, and in response to receiving the control instruction, execute the test script to output a test instruction to the tested server; the tested server, configured to, in response to receiving the test instruction, test codes before the project codes, and output running data to the testing server. The system according to embodiments can facilitate developers to perform continuous software integration and implement automated tests, and achieve the purpose of efficiently developing software.

### TECHNICAL FIELD

The present disclosure relates to the field of test technologies, and in particular, to a continuous integration automated test system and method, an electronic device, and a storage medium.

### BACKGROUND

At present, in response to software verification requirements during continuous software integration, there is a need to evolve from a semi-automated test era to an automated test era. For automated detection after construction in the continuous integration and an inspection process after problems affecting the integration are resolved, a test process is gradually developing and evolving to a full automated test era, and there is also an urgent need for an advanced, new implementation manner that can be applied in the continuous integration to satisfy requirements of service and system development.

### SUMMARY

The present disclosure provides a continuous integration automated test system and method, an electronic device, and a storage medium to solve deficiencies of related technologies.

According to a first aspect of embodiments of the present disclosure, there is provided a continuous integration automated test system, including: a deploying server, a testing server and a tested server, where the deploying server is connected with the testing server, and the testing server is connected with the tested server;
the deploying server is configured to, in response to detecting one or more events each indicating deploying project codes to the tested server, for each of the one or more events, acquire a test script of a project to which the project codes belong, and send the test script to the testing server, then send a control instruction for executing the test script to the testing server;
the testing server is configured to receive the test script through a designated port and store the test script in a corresponding project folder, and in response to receiving the control instruction, execute the test script to output a test instruction to the tested server; and
the tested server is configured to, in response to receiving the test instruction, test codes before the project codes, and output running data to the testing server.

In some embodiments, the deploying server is provided with submission behavior scripts and pull scripts; the submission behavior scripts are configured to, in response to detecting the event indicating deploying the project codes to the tested server, trigger the pull scripts; and the pull scripts are configured to pull the test script of the project to which the project codes belong from a test script platform connected with the deploying server, and send the test script to the testing server.

In some embodiments, the testing server is further configured to, for each of the one or more events, generate a test report template corresponding to the event, generate a test report of the event according to the test report template and the running data, and output the test report according to a preset notification manner in the test report template.

In some embodiments, the testing server is provided with project configuration scripts; the project configuration scripts are configured to generate a test report template corresponding to the project, and the test report template includes a first parameter of the test report; and the first parameter includes at least one of the following: a name, a storage location, or a preset notification manner of the test report.

In some embodiments, the testing server is provided with report style scripts; the report style scripts are configured to construct a second parameter of the test report; and the second parameter includes at least one of the following: a style or content attributes.

In some embodiments, the testing server is provided with email scripts, and the email scripts are configured to designate email recipient information, package a browsing path of the test report, and write the test report and the browsing path into an email, then send the email to one or more designated email recipients.

In some embodiments, the testing server is provided with regular test scripts, and the regular test scripts are configured to trigger test scripts in the testing server according to a preset period; and the test scripts are scripts that match project codes in the tested server.

In some embodiments, the testing server includes a database; and the database is configured to store running data generated in each test.

According to a second aspect of the embodiments of the present disclosure, there is provided a continuous integration automated test method, including:
in response to detecting one or more events each indicating deploying project codes to a tested server, for each of the one or more events, acquiring, by a deploying server, a test script of a project to which the project codes belong;
sending, by the deploying server, the test script to a testing server, then sending a control instruction for executing the test script to the testing server;
receiving, by the testing server, the test script through a designated port and storing the test script in a corresponding project folder, and in response to receiving the control instruction, executing the test script to output a test instruction to the tested server; and
in response to receiving the test instruction, testing, by the tested server, codes before the project codes, and outputting running data to the testing server.

In some embodiments, the deploying server is provided with submission behavior scripts and pull scripts; acquiring the test script of the project to which the project codes belong includes:
executing, by the deploying server, the submission behavior scripts to trigger the pull scripts in response to detecting the event indicating deploying the project codes to the tested server;
executing, by the deploying server, the pull scripts to pull the test script of the project to which the project codes belong from a test script platform connected with the deploying server; and
sending, by the deploying server, the test script to the testing server.

In some embodiments, the method further including:
for each of the one or more events, generating, by the testing server, a test report template corresponding to the event, generating a test report of the event according to the test report template and the running data, and outputting the test report according to a preset notification manner.

In some embodiments, the testing server is provided with project configuration scripts; for each of the one or more events, generating, by the testing server, the test report template corresponding to the event includes:
generating, by the project configuration scripts, a test report template corresponding to the project, where the test report template includes a first parameter of the test report; and
the first parameter includes at least one of the following: a name, a storage location, or a preset notification manner of the test report.

In some embodiments, the testing server is provided with report style scripts; for each of the one or more events, generating the test report of the event according to the test report template and the running data includes:
determining, by the report style scripts, a second parameter of the running data in the test report template, where the second parameter includes at least one of the following: a style or content attributes;
updating a parameter of the running data to the second parameter, and filling the updated parameter into the test report template to generate the test report of the event.

In some embodiments, the testing server is provided with email scripts; outputting the test report according to the preset notification manner includes:
designating, by the email scripts, email recipient information, packaging a browsing path of the test report, and write the test report and the browsing path into an email, then sending the email to one or more designated email recipients.

In some embodiments, the testing server is provided with regular test scripts; the method further includes:
triggering, by the regular test scripts, test scripts in the testing server according to a preset period, where the test scripts are scripts that match project codes in the tested server.

According to a third aspect of the embodiments of the present disclosure, there is provided a server, including:
a processor; and
a memory for storing a computer program executable by the processor;
where the processor is configured to execute the computer program in the memory to implement the methods as described above.

According to a fourth aspect of the embodiments of the present disclosure, there is provided a computer readable storage medium, where an executable computer program in the computer readable storage medium is executed by a processor of an electronic device to implement the methods as described above.

The technical solutions according to the embodiments of the present disclosure can achieve the following beneficial effects.

As can be known from the above embodiments, in the solutions according to the embodiments of the present disclosure, a deploying server is configured to, in response to detecting one or more events each indicating deploying project codes to a tested server, for each of the one or more events, acquire a test script of a project to which the project codes belong, and send the test script to a testing server, then send a control instruction for executing the test script to the testing server. Thus, a developer can have access to the deploying server through Internet connection and thus deploy the project codes by the deploying server, which achieves the effect of being not restricted by geographical location. The testing server is configured to receive the test script through a designated port and store the test script in a corresponding project folder, and in response to receiving the control instruction, execute the test script to output a test instruction to the tested server. The tested server is configured to, in response to receiving the test instruction, test codes before the project codes and output running data to the testing server. It can be seen that the system according to the embodiments can facilitate the developer to perform continuous software integration, and by performing automated tests (i.e., regression testing) on codes before newly deployed project codes, i.e., old codes, each time, can ensure the efficiency of software development.

It should be understood that the above general description and the following detailed description are only exemplary and explanatory and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating a continuous integration automated test system according to an exemplary embodiment.

FIG. 2 is a block diagram illustrating another continuous integration automated test system according to an exemplary embodiment.

FIG. 3 is a flowchart illustrating a continuous integration automated test method according to an exemplary embodiment.

FIG. 4 is a block diagram illustrating a server according to an exemplary embodiment.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

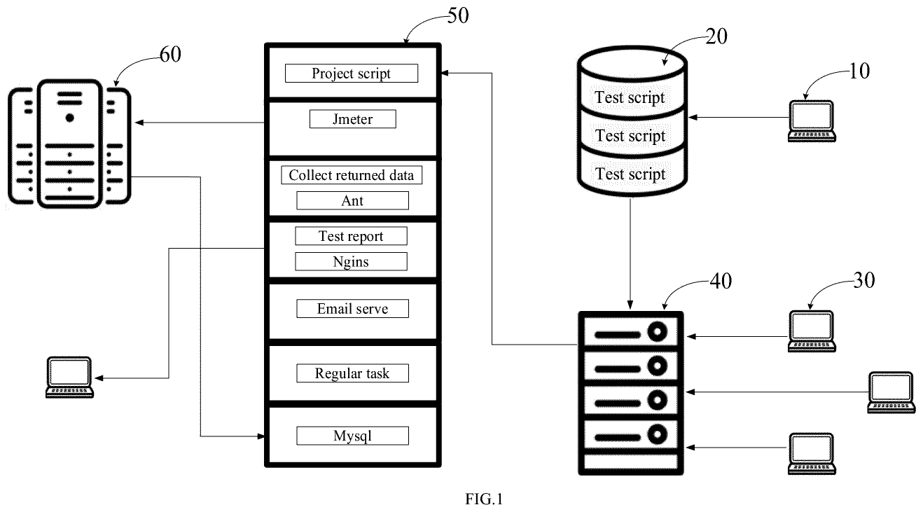

To solve the above technical problems, in an embodiment of the present disclosure, there is provided a continuous integration automated test system. FIG. 1 is a block diagram illustrating a data processing system according to an exemplary embodiment. Referring to FIG. 1, a continuous integration automated test system includes: a deploying server 40, a testing server 50 and a tested server 60. The deploying server 40 is connected with the testing server 50, and the testing server 50 is connected with the tested server 60.

The deploying server 40 is configured to, in response to detecting one or more events each indicating deploying project codes to the tested server 60, for each of the one or more events, acquire a test script of a project to which the project codes belong, and send the test script to the testing server 50, then send a control instruction for executing the test script to the testing server 50.

The testing server 50 is configured to receive the test script through a designated port and store the test script in a corresponding project folder, and in response to receiving the control instruction, execute the test script to output a test instruction to the tested server 60.

The tested server 60 is configured to, in response to receiving the test instruction, test codes before the project codes, and output running data to the testing server.

It should be noted that a developer can deploy new project codes to the tested server 60 through the deploying server 40, that is, integrate the new project codes into existing codes of a project to which the new project codes belong. Accordingly, a label (or version) of the project may be updated. In this embodiment, by executing a test script, the testing server can test the existing codes (that is, old codes before the deployed new project codes) in the project whose label (or version) has been updated, which can be called regression testing, and thus can determine whether the new project codes affect the performance of the old codes. Therefore, the developer can continuously deploy new project codes, and the testing server can continuously perform regression testing, which can achieve better combinations of continuous integration and automated tests, and is beneficial to improving the efficiency of project development.

In the solutions according to the embodiments of the present disclosure, a test script platform acquires and stores test scripts of respective projects, which achieves the effect of managing the test scripts in a unified manner. The deploying server, in response to detecting one or more events each indicating deploying project codes, for each of the one or more events, acquires a test script corresponding to the project codes, and sends the test script to the testing server, then sends a control instruction for executing the test script to the testing server. Thus, the developer can have access to the deploying server through Internet connection and thus deploy the project codes by the deploying server, which achieves the effect of being not restricted by geographical location. The testing server executes the test script under control of the control instruction to achieve the effect of testing the project codes deployed by the developer. It can be seen that the system according to this embodiment can facilitate the developer to perform continuous software integration and implement automated tests, and achieve the purpose of efficiently developing software.

In an embodiment, a first terminal 10 may include a tablet computer, a personal computer or other devices. The first terminal 10 is provided with a test environment, such as a software environment or an operation system required for writing test scripts, in which a tester is allowed to write test scripts of respective projects. Moreover, after the test scripts are written, the first terminal 10 can receive a push operation from the tester, and push the test scripts of respective projects to the test script platform 20. It should be noted that, in this example, the tester and subsequent developer are related to solutions in which they are involved, and in practical applications, they may be the same person or the same team.

In an embodiment, the test script platform 20 may be a storage management system, a platform, a server, a server cluster, or the like, and can be connected with at least one first terminal 10. Their connection manner may include a wired connection or a wireless connection. The wireless connection may include a Bluetooth connection, a WiFi connection, or the like. It should be understood that, as long as communication and data transmission between the test script platform 20 and the first terminal 10 can be implemented, the connection manner is not limited in this embodiment. The test script platform 20 can acquire test scripts of respective projects and store the test scripts locally. The deploying server 40 can acquire the test scripts corresponding to the respective projects from the test script platform 20. In this way, in this embodiment, the test script platform 20 can receive test scripts pushed by respective first terminals 10, and can manage test scripts of all projects in a unified manner, which is suitable for multiple scenarios where multiple projects are tested at the same time, and is beneficial to improving management efficiency.

In an embodiment, the deploying server 40 may be a platform, a server, a server cluster, or the like, and can be connected with at least one second terminal 30. Their connection manner may include a wired connection or a wireless connection. The wireless connection may include a Bluetooth connection, a WiFi connection, or the like. It should be understood that, as long as communication and data transmission between the deploying server 40 and the second terminal 30 can be implemented, the connection manner is not limited in this embodiment. The second terminal 30 may include a tablet computer, a personal computer or other devices. The second terminal 30 is provided with a development environment, such as a software environment or an operation system required for writing project codes, in which the developer is allowed to write project codes of respective projects. Moreover, after the project codes are written, the second terminal 30 can receive a push operation from the developer, and push the project codes of respective projects to the deploying server 40. The deploying server 40 can acquire the project codes of respective projects, and deploy the project codes to the tested server 60. Alternatively, the second terminal 30 can receive a push operation from the developer, and push the project codes of respective projects to the tested server 60. It should be understood that, for a deployment process, reference may be made to solutions in related art, such as compiling and packaging, which is not limited in this embodiment.

In this embodiment, the deploying server 40 is provided with submission behavior scripts (such as kenkins scripts), and pull scripts. The submission behavior scripts can be configured to detect an event of deploying project codes to the tested server. For example, the deploying server 40, when receiving a deployment operation of a developer on the second terminal 30, can determine that an event of deploying project codes is detected, or after detecting a deployment operation of a developer and completion of deployment of project codes, can determine that an event of deploying project codes is detected, or after detecting a deployment success message returned by the tested server following completion of deploying project codes, can determine that an event of deploying project codes is detected. The deploying server 40, when the event of deploying project codes to the tested server is detected, can trigger the pull scripts. The pull scripts are configured to pull a test script corresponding to the project codes from the test script platform 20 and send the test script to the testing server 50.

It should be noted that, a developer, when developing project codes of respective projects, usually designates a project to which project codes belong, or a storage path of project codes, or the like. Therefore, during deployment of project codes, a deployment request sent by the second terminal 30 to the deploying server 40 may carry attribute data such as a project name, a project folder or a project storage path of the project corresponding to the project codes. The deploying server 40 can pull a test script from the test script platform 20 based on the attribute data.

In this embodiment, the deploying server 40, after detecting that the pull scripts successfully pull corresponding test script from the test script platform 20 or successfully send the test script to the testing server 50, can generate a control instruction for executing the test script, and send the control instruction to the testing server 50.

In this embodiment, the deploying server 40, after detecting an event indicating deploying project codes, mainly performs the following: first, pulling a test script corresponding to the deployed project codes from the test script platform 20; second, pushing the test script to the testing server 50 and sending a control instruction for executing the test script. In this way, in this embodiment, the deploying server 40 can implement detection of deployment of code and trigger code tests, which can achieve the effect of being not restricted by geographical location, or in a case where communication with the deploying server 40 can be implemented, for example, through an Internet connection, it is convenient for a developer to perform continuous software integration, so as to achieve the purpose of efficiently developing software.

In an embodiment, the testing server 50 may be a platform, a server, a server cluster, or the like, and can be connected with the deploying server 40. Their connection manner may include a wired connection or a wireless connection. The wireless connection may include a Bluetooth connection, a WiFi connection, or the like. It should be understood that, as long as communication and data transmission between the testing server 50 and the deploying server 40 can be implemented, the connection manner is not limited in this embodiment. In an example, the testing server may include at least one designated port, and the at least one designated port may be configured to transmit test scripts and monitor control instructions, so as to achieve the effect of communication and data transmission with the deploying server. Therefore, the testing server and the deploying server do not need to be disposed in the same geographical location, which is convenient for flexible configuration.

A project storage region can be disposed for each project in the testing server 50. The testing server 50, after receiving the test script pushed by the deploying server 40, can store the test script in a project storage region of the project corresponding to the test script. By disposing the project storage region for each project, it is convenient to read and store data for multiple test projects at the same time, which is beneficial to improving test efficiency.

The testing server 50, after receiving the control instruction for executing test script, can execute corresponding test script (i.e., the test script pushed by the deploying server 40). Or, the testing server 50 can send the control instruction to the tested server 60 according to test steps in the test script or test project. The tested server 60 can run deployed project codes in response to the control instruction. The tested server 60 may include a server, a server cluster, or the like, and can be connected with the testing server 50. Their connection manner may include a wired connection or a wireless connection. The wireless connection may include a Bluetooth connection, a WiFi connection, or the like. It should be understood that, as long as communication and data transmission between the tested server 60 and the testing server 50 can be implemented, the connection manner is not limited in this embodiment.

The testing server 50 can receive running data fed back by the tested server 60. The running data refers to intermediate data or final data that can be generated by the tested server 60 according to a certain step in project codes or a certain step in test script during running of the project codes. In addition, the testing server 50 can be provided with a database, such as a MySQL database, and the database can be configured to store running data generated in each test.

In an example, at the beginning of testing project codes each time, the testing server 50 can generate test report templates corresponding to respective events according to preset report configuration files, and at the end of testing project codes each time or at a preset test time, the testing server 50 generates test reports of the respective events according to the test report templates and the running data, and outputs the test reports in a preset notification manner.

In an example, the testing server 50 is provided with project configuration files. Project configuration scripts can be provided in the project configuration files. The project configuration scripts are configured to execute test scripts and designate a first parameter of a test report. The first parameter includes at least one of the following: a name, a storage location, or a preset notification manner of the test report. It should be noted that the name of the test report can be determined according to a name of a project in combination with a timestamp, or by adding or suffixing 1 to a name of a test report of a previous version. The way to determine the name of the test report can be chosen according to specific scenarios, which is not limited here. The preset notification manner may include, but are not limited to, emails, short messages, instant messages, etc. The preset notification manner can be provided according to specific scenarios, and is not limited here.

In an example, the testing server 50 is provided with an ant system. The ant system is an open source system construction tool based on Java, and can help developers to complete functions such as compiling, packaging, and uploading. The testing server 50 can be provided with report style scripts, and the report style scripts can be provided in the ant system. The report style scripts can be configured to construct a second parameter of a test report. The second parameter includes at least one of the following: a style or content attributes. For example, a test report can include 2 content blocks, namely, a statistics block and a list block. The statistics block can include the following contents: statistics on a number, a success rate, a failure rate, etc., of multiple cases during a test. The list block can include successful cases, failed cases, etc. The 2 blocks above are a style of the test report, and contents included in each block are content attributes. It should be understood that the above example is used only to explain the second parameter, which can be set according to specific scenarios, and corresponding solutions fall within the protection scope of the present disclosure. In this way, in this example, the report style scripts can be provided according to different projects, or personalized test reports, such as performance test reports or function test reports, can be customized according to projects, so as to satisfy requirements for test reports in different application scenarios.

In an example, the testing server 50 is provided with an email service, and email scripts can be provided in the email service. The email scripts can be configured to designate email recipient information, package a browsing path of a test report, and write the test report and the browsing path into an email, then send the email to one or more designated email recipients, such as developers, supervisors or project team members. Therefore, in this example, the test report can be downloaded locally to facilitate reading locally, and can be browsed online according to the browsing path to satisfy application requirements of different developers.

It should be noted that, during generation of a test report, a report style script does not know which project the test report belongs to and storage location of the test report, so that the report style script is configured to generate test reports, but is not limited to being configured to generate a test report for a certain project. Here, project configuration scripts can designate a storage location for the test report generated by the report style script and generate a name of the test report, that is, incorporate the test report into a certain project. In this way, the report style scripts and the project configuration scripts can cooperate to generate test reports for respective projects. Email scripts, when sending the test report, can package the above-mentioned designated location to acquire a browsing path, and write the test report into an email, then send the email to recipients, so as to complete the sending of the test report.

In an embodiment, an operation system, such as a Linux system, is installed in the testing server 50. In this embodiment, regular test scripts can be provided in the Linux system, and the regular test scripts can be configured to trigger test scripts in the testing server 50 according to a preset period, where the test scripts are scripts that match project codes in the tested server 60. Or, the regular test scripts can be configured to inspect project tests at regular intervals, execute test scripts corresponding to to-be-inspected projects, and receive running data fed back by the tested server 60. And the regular test scripts can be configured to generate test reports based on the running data, package browsing addresses of the test reports, send the test reports and their browsing addresses to designated email recipients, and additionally perform other steps. Therefore, the execution of the regular test scripts can be completed independently by the testing server without participation of the test script platform and the deploying server, and the testing server has functions of automated tests or regular inspection of test.

It should be noted that, to describe a continuous integration automated test system in the embodiments of the present disclosure, a deploying server, a testing server, and a tested server are provided. These servers each have corresponding functions, and cooperate to realize continuous integration and automated tests. It should be understood that the above-mentioned servers distributed in the system are divided only logically, and can be integrated physically into one of server entities, for example, the deploying server and the testing server are integrated into the tested server. The skilled person can select an appropriate arrangement manner according to specific scenarios, and corresponding solutions fall within the protection scope of the present disclosure.

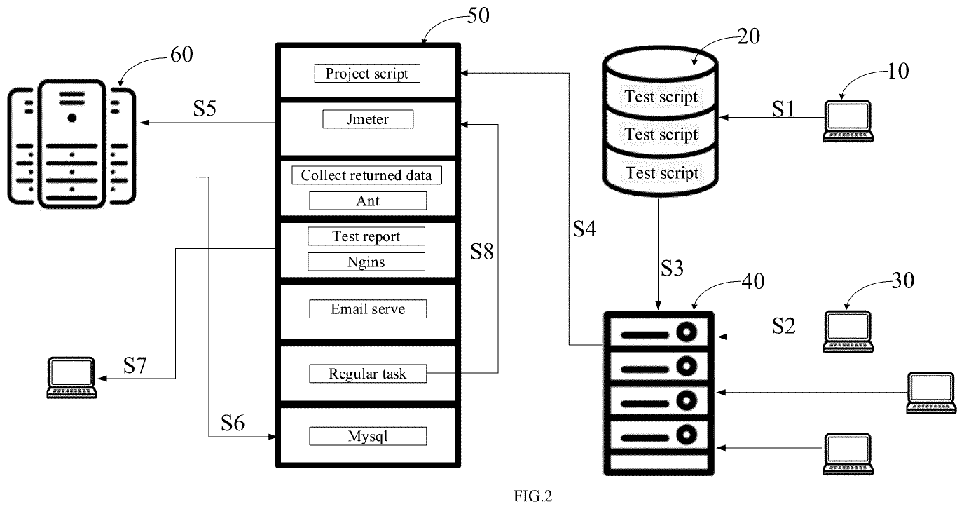

With reference to the system described in FIGS. 1 and 2, a workflow of the continuous integration automated test system will be described below.

S1, a tester writes test scripts of respective projects by the first terminals 10. After the test scripts are written, the tester can push the test scripts to the test script platform 20 through the first terminals 10. Accordingly, the test script platform 20 can acquire the test scripts. The tester can manage test scripts of all projects in a unified manner through the test script platform 20.

It should be noted that step S1 does not need to be performed in each test process, because the test scripts can be reused, and the tester writes new test scripts only when a project needs. In other words, step S1 is only an optional step during a complete project test, but is not a limitation to a solution.

S2, the developer writes project codes of respective projects by second terminals 30. After the project codes are written, the developer can push the project codes to the deploying server 40 through the second terminals 30, and deploy the project codes to the tested server 60 through the deploying server 40.

S3, submission behavior scripts in the deploying server 40, after detecting an event indicating deploying the project codes, trigger pull scripts. The pull scripts pull a test script corresponding to the project codes from the test script platform 20.

S4, the pull scripts push the test script to the testing server 50. Moreover, the deploying server 40 sends a control instruction to the testing server 50.

S5, the testing server 50, after receiving the control instruction from the deploying server 40, executes corresponding test script, and during the execution of the test script, sends the control instruction to the tested server 60.

S6, the tested server 60 runs the deployed project codes according to the control instruction, and feeds generated running data back to the testing server 50.

S7, an ant system in the testing server 50 constructs a Jmeter tool, where the Jmeter tool is a stress test tool based on Java for performing stress tests on software and performance tests on static and dynamic resources (files, Servlets, Perl scripts, java objects, databases and queries, FTP servers, etc.). The testing server 50 can use the Jmeter tool to collect running data and store the running data in a database MySQL. Moreover, the ant system in the testing server 50 can construct browsing addresses of test reports, and package the browsing addresses into email scripts. In addition, the ant system can activate email services, store the test reports and their browsing addresses in an email, and send the email to designated email recipients.

S8, regular test scripts in the testing server 50, after detecting that a preset duration has lapsed, trigger a test script of an inspected project, and then steps S5-S7 are performed.

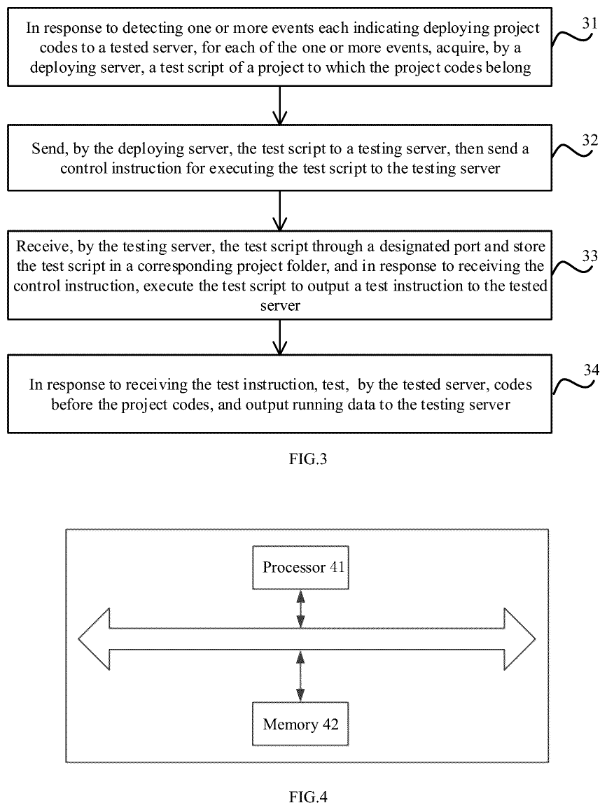

FIG. 3 is a flowchart illustrating a continuous integration automated test method according to an exemplary embodiment. Referring to FIG. 3, the continuous integration automated test method includes:

S31, in response to detecting one or more events each indicating deploying project codes to a tested server, for each of the one or more events, a deploying server acquires a test script of a project to which the project codes belong.

S32, the deploying server sends the test script to a testing server, then sends a control instruction for executing the test script to the testing server.

S33, the testing server receives the test script through a designated port and stores the test script in a corresponding project folder, and in response to receiving the control instruction, executes the test script to output a test instruction to the tested server.

S34, in response to receiving the test instruction, the tested server tests, i.e., performs regression tests on, codes before the deployed project codes, and outputs running data to the testing server.

In an embodiment, the deploying server is provided with submission behavior scripts and pull scripts; acquiring the test script of the project to which the project codes belong includes:
executing, by the deploying server, the submission behavior scripts to trigger the pull scripts in response to detecting the event indicating deploying the project codes to the tested server;
executing, by the deploying server, the pull scripts to pull the test script of the project to which the project codes belong from a test script platform connected with the deploying server; and
sending, by the deploying server, the test script to the testing server.

In an embodiment, the method further includes:
for each of the one or more events, generating, by the testing server, a test report template corresponding to the event, generating a test report of the event according to the test report template and the running data, and outputting the test report according to a preset notification manner.

In an embodiment, the testing server is provided with project configuration scripts; for each of the one or more events, generating, by the testing server, the test report template corresponding to the event includes:
generating, by the project configuration scripts, a test report template corresponding to the project, where the test report template includes a first parameter of the test report; and the first parameter includes at least one of the following: a name, a storage location, or a preset notification manner of the test report.

In an embodiment, the testing server is provided with report style scripts; for each of the one or more events, generating the test report of the event according to the test report template and the running data includes:
determining, by the report style scripts, a second parameter of the running data in the test report template, where the second parameter includes at least one of the following: a style or content attributes;
updating a parameter of the running data to the second parameter, and filling the updated parameter into the test report template to generate the test report of the event.

In an embodiment, the testing server is provided with email scripts; outputting the test report according to the preset notification manner includes:
designating, by the email scripts, email recipient information, packaging a browsing path of the test report, and write the test report and the browsing path into an email, then sending the email to one or more designated email recipients.

In an embodiment, the testing server is provided with regular test scripts; the method further includes:
triggering, by the regular test scripts, test scripts in the testing server according to a preset period, where the test scripts are scripts that match project codes in the tested server.

It should be understood that the method according to the embodiments of the present disclosure corresponds to the system, and for specific contents, reference may be made to the contents in system embodiments, which will not be repeated here.

In an exemplary embodiment, referring to FIG. 4, there is provided a server, including:
a processor 41; and
a memory 42 for storing a computer program executable by the processor;
where the processor 41 is configured to execute the computer program in the memory to implement the steps in the method.

In an exemplary embodiment, there is provided a computer readable storage medium, such as a memory including instructions. The executable computer program can be executed by the processor to implement the steps in the method. The readable storage medium may be a Read Only Memory (ROM), a Random Access Memory (RAM), a CD-ROM, a magnetic tape, a floppy disk, an optical data storage device, or the like.

Other embodiments of the present disclosure will be readily apparent to those skilled in the art after considering the specification and practicing the contents disclosed herein. The present disclosure is intended to cover any variations, uses, or adaptations of the present application, which follow the general principle of the present disclosure and include common knowledge or conventional technical means in the art that are not disclosed in the present application. The specification and examples are to be regarded as illustrative only. The true scope and spirit of the present disclosure are pointed out by the following claims.

It is to be understood that the present disclosure is not limited to the precise structures that have described and shown in the drawings, and various modifications and changes can be made without departing from the scope thereof. The scope of the disclosure is to be limited only by the appended claims.

1. A continuous integration automated test system, comprising:
a deploying server, a testing server and a tested server, wherein the deploying server is connected with the testing server, and the testing server is connected with the tested server;
the deploying server is configured to, in response to detecting one or more events each indicating deploying project codes to the tested server, for each of the one or more events, acquire a test script of a project to which the project codes belong, and send the test script to the testing server, then send a control instruction for executing the test script to the testing server;
the testing server is configured to receive the test script through a designated port and store the test script in a corresponding project folder, and in response to receiving the control instruction, execute the test script to output a test instruction to the tested server; and
the tested server is configured to, in response to receiving the test instruction, test codes before the project codes, and output running data to the testing server.

2. The system according to claim 1, wherein the deploying server is provided with submission behavior scripts and pull scripts;
the submission behavior scripts are configured to, in response to detecting the event indicating deploying the project codes to the tested server, trigger the pull scripts; and
the pull scripts are configured to pull the test script of the project to which the project codes belong from a test script platform connected with the deploying server, and send the test script to the testing server.

3. The system according to claim 1, wherein the testing server is further configured to, for each of the one or more events, generate a test report template corresponding to the event, generate a test report of the event according to the test report template and the running data, and output the test report according to a preset notification manner in the test report template.

4. The system according to claim 3, wherein the testing server is provided with project configuration scripts; the project configuration scripts are configured to generate a test report template corresponding to the project, and the test report template comprises a first parameter of the test report; and the first parameter comprises at least one of the following: a name, a storage location, or a preset notification manner of the test report.

5. The system according to claim 3, wherein the testing server is provided with report style scripts; the report style scripts are configured to construct a second parameter of the test report; and the second parameter comprises at least one of the following: a style or content attributes.

6. The system according to claim 3, wherein the testing server is provided with email scripts, and the email scripts are configured to designate email recipient information, package a browsing path of the test report, and write the test report and the browsing path into an email, then send the email to one or more designated email recipients.

7. The system according to claim 1, wherein the testing server is provided with regular test scripts, and the regular test scripts are configured to trigger test scripts in the testing server according to a preset period; and the test scripts are scripts that match project codes in the tested server.

8. The system according to claim 1, wherein the testing server comprises a database; and
the database is configured to store running data generated in each test.

9. A continuous integration automated test method, comprising:
in response to detecting one or more events each indicating deploying project codes to a tested server, for each of the one or more events, acquiring, by a deploying server, a test script of a project to which the project codes belong;
sending, by the deploying server, the test script to a testing server, then sending a control instruction for executing the test script to the testing server;
receiving, by the testing server, the test script through a designated port and storing the test script in a corresponding project folder, and in response to receiving the control instruction, executing the test script to output a test instruction to the tested server; and
in response to receiving the test instruction, testing, by the tested server, codes before the project codes, and outputting running data to the testing server.

10. The method according to claim 9, wherein the deploying server is provided with submission behavior scripts and pull scripts; acquiring the test script of the project to which the project codes belong comprises:
executing, by the deploying server, the submission behavior scripts to trigger the pull scripts in response to detecting the event indicating deploying the project codes to the tested server;
executing, by the deploying server, the pull scripts to pull the test script of the project to which the project codes belong from a test script platform connected with the deploying server; and
sending, by the deploying server, the test script to the testing server.

11. The method according to claim 9, further comprising:
for each of the one or more events, generating, by the testing server, a test report template corresponding to the event, generating a test report of the event according to the test report template and the running data, and outputting the test report according to a preset notification manner.

12. The method according to claim 11, wherein the testing server is provided with project configuration scripts; for each of the one or more events, generating, by the testing server, the test report template corresponding to the event comprises:
generating, by the project configuration scripts, a test report template corresponding to the project, wherein the test report template comprises a first parameter of the test report; and the first parameter comprises at least one of the following: a name, a storage location, or a preset notification manner of the test report.

13. The method according to claim 11, wherein the testing server is provided with report style scripts; for each of the one or more events, generating the test report of the event according to the test report template and the running data comprises:
determining, by the report style scripts, a second parameter of the running data in the test report template, wherein the second parameter comprises at least one of the following: a style or content attributes;
updating a parameter of the running data to the second parameter, and filling the updated parameter into the test report template to generate the test report of the event.

14. The method according to claim 11, wherein the testing server is provided with email scripts; outputting the test report according to the preset notification manner comprises:
designating, by the email scripts, email recipient information, packaging a browsing path of the test report, and write the test report and the browsing path into an email, then sending the email to one or more designated email recipients.

15. The method according to claim 9, wherein the testing server is provided with regular test scripts; the method further comprises:
triggering, by the regular test scripts, test scripts in the testing server according to a preset period, wherein the test scripts are scripts that match project codes in the tested server.

16. A server, comprising:
a processor; and
a memory for storing a computer program executable by the processor;
wherein the processor is configured to execute the computer program in the memory to implement operations comprising:
in response to detecting one or more events each indicating deploying project codes to a tested server, for each of the one or more events, acquiring, by a deploying server, a test script of a project to which the project codes belong;
sending, by the deploying server, the test script to a testing server, then sending a control instruction for executing the test script to the testing server;
receiving, by the testing server, the test script through a designated port and storing the test script in a corresponding project folder, and in response to receiving the control instruction, executing the test script to output a test instruction to the tested server; and
in response to receiving the test instruction, testing, by the tested server, codes before the project codes, and outputting running data to the testing server.

17. A non-volatile computer readable storage medium, wherein an executable computer program in the computer readable storage medium is executed by a processor of an electronic device to implement a method according to claim 9.

18. The server according to claim 16, wherein the deploying server is provided with submission behavior scripts and pull scripts; acquiring the test script of the project to which the project codes belong comprises:
executing, by the deploying server, the submission behavior scripts to trigger the pull scripts in response to detecting the event indicating deploying the project codes to the tested server;
executing, by the deploying server, the pull scripts to pull the test script of the project to which the project codes belong from a test script platform connected with the deploying server; and
sending, by the deploying server, the test script to the testing server.

19. The server according to claim 16, the operations further comprise:
for each of the one or more events, generating, by the testing server, a test report template corresponding to the event, generating a test report of the event according to the test report template and the running data, and outputting the test report according to a preset notification manner.

20. The server according to claim 19, wherein the testing server is provided with project configuration scripts; for each of the one or more events, generating, by the testing server, the test report template corresponding to the event comprises:
generating, by the project configuration scripts, a test report template corresponding to the project, wherein the test report template comprises a first parameter of the test report; and the first parameter comprises at least one of the following: a name, a storage location, or a preset notification manner of the test report.
